(19) United States
(12) Patent Application Publication
(10) Pub. No.: US 2003/0008659 A1
(43) Pub. Date: Jan. 9, 2003

(54) Locating items

(76) Inventors: John Deryk Waters, Bath (GB); Salil Pradhan, Santa Clara, CA (US); James Thomas Edward McDonnell, Clifton Bristol (GB); John Lawrence, Birmingham (GB)

Correspondence Address: LADAS & PARRY, Suite 2100, 5670 Wilshire Boulevard, Los Angeles, CA, 90036-5679, US

(21) Appl. No.: 09/885,289

(22) Filed: Jun. 20, 2001

(51) Int. Cl. H04Q 7/20

(52) U.S. Cl. 455/456; 455/435; 455/553

(57) ABSTRACT

A mobile telecommunications device (10, 12, 14, 16) has both short range, piconet, telecommunications ability and long range cellular telecommunications ability. Mobile items of personal property, eg a pair of glasses (18) can be lost by an individual. The telecommunications devices (10, 12, 14, 16) keep an activity log of the times of existence and members of piconets of which they have been members. If a lost item (18) is not in the present piconet (26) of a user's device (10) it can backtrack through its activity log to find the last piconet for which both it and the missing item (18) were members, and can identify from the activity log what other devices (12, 14, 16) were present in that particular piconet. The device (10) can then contact the devices (12, 14, 16) and determine whether the missing item 18 is presently part of their piconet, and hence can locate the missing item if it is present in one of their piconets. The device may also geostamp its activity records and/or be aware of its geographical position.

This invention relates to locating items, in particular lost items.

A well known problem is knowing one had an item earlier in time but being unable to find it easily later on. Solutions to this problem are myriad and include devices which beep when they receive a trigger signal (for example sound, e.g. clapping, or an electromagnetic signal), devices which are magnetically or radio frequency detected as they pass through portals or past transducers at key points in a building (e.g. RF tags on files and scanners at doorways to rooms), and car theft tracking devices which broadcast their position generally, possibly upon activation, to detectors.

It is an aim of the present invention to provide an alternative way of locating lost items.

According to a first aspect of the invention comprises a method of locating a missing item, the item being capable of communicating its presence to a piconet telecommunications device, comprising:

(i) there being a plurality of piconet devices capable of forming a short range piconet;

(ii) having the piconet devices establish which other piconet devices are members of the piconet to which they belong at a particular point in time, and having the piconet devices create an activity log correlating at least time and the identity of which piconet devices were in communication at that point in time;

(iii) establishing whether the missing item is present in the current piconet of said piconet device and/or reviewing the activity log to establish whether a record exists of a historic piconet to which both the missing item and a contactable other piconet device belonged at the time that the historic piconet existed.

Preferably the method also comprises the step:

(iv) if a said other piconet device is identified, contacting said other piconet device and establishing whether the missing item is part of the piconet that now includes said other piconet device.

Thus by backtracking the activity log a contactable piconet device can be found that is known to have been in proximity to the missing item at one time, and that “one time close” piconet device can be asked whether the missing item is still close enough to be in its current piconet. It will be appreciated that piconet devices can communicate using short range telecommunications, such as Bluetooth (TM) or IEEE 802.11, over a distance of a few meters, or perhaps a few tens of meters.

The each piconet device preferably creates its own activity log and stores it in itself, in its own memory. However, an arrangement can be envisaged where a piconet device stores its activity log remote from itself (possibly for example storing it to a PC when it comes close enough to a chosen piconet-connectable PC). More than one piconet device may contribute information to a common database, or activity log, relating to which devices were close enough, at which time, to be in the same piconet. There may be a common log or storage place for several devices.

However, it is preferred that each piconet device creates its own “personal” piconet activity log and stores it within itself.

The method may comprise having a search-requesting piconet device check its own piconet for the presence of the missing device before screening the activity log, or its own piconet activity log to look for a historic piconet to which both itself, the missing item, and said other piconet device belonged, and then contacting said other piconet to establish whether the missing item is part of the current piconet of said other piconet device.

Preferably the method comprises having the search-requesting piconet device and said other piconet device be capable of long range telecommunication and having the search-requesting device contact said other device using its long range telecommunications capabilities.

Thus their long range telecommunications capabilities of the search-requesting and said other device mean that the search-requesting piconet device can communicate with said other piconet device without having to wait for them to come close enough together for the piconet telecommunications to be operable.

Of course, in certain circumstances it may be acceptable to use only short range piconet telecommunications in the search for the missing item, for example in an environment where there are a lot of piconet devices and good physical area coverage is provided. An office environment may be such an example. It is preferred however to have the ability to search using long range telecommunications to provide a bridge between two separate piconets (the one with the search-requesting device, and the one with said other device).

The method preferably comprises asking the piconet devices with long range telecommunication capabilities whether the missing item is presently in their local piconet in reverse chronological order that they are known from the activity log to have been in contact with the missing item, asking the device with the most recent contact first, and more out of date contacts later.

The method preferably comprises having a cut off point beyond which the search does not backtrack for contacts. This cut off point may be a time back beyond which the search does not go, or it may be the number of long distance telecommunications contacts made to other devices. A combination of these two criteria may be used to control the cut off point.

The search-requesting piconet device may itself have a long distance telecommunication capability, or it may have only piconet range telecommunications, but be in contact with a piconet member which does have long distance telecommunications ability and use their long range telecommunications.

The search-requesting piconet device may sequentially ask those other piconet devices that it identifies from its (or the) activity log for information on whether the missing item is in their current piconet. Alternatively, the search-requesting piconet device may simultaneously or substantially simultaneously, ask a plurality of other devices for such information, without waiting for a reply from the first said other device interrogated. This can be helpful if the long distance telecommunications network does not necessarily generate a fast reply. For example e-mail can take hours, depending upon network availability and traffic.

The long distance telecommunications could be a wireless network, e.g. satellite link, or cellular (for example a cellular telephone network), or internet based (some, or even many, said other devices could be connected to the internet, e.g. they could be PCs) or a land cable communication network.

The method may include- having the piconet devices record their geographical, or physical, location at the time that a piconet exists. Thus the activity log may be time-stamped and location stamped.

It may not always be possible to get a location fix for a piconet device when it is in a network (nor a location fix for any other piconet members) and so not all activity log entries for a piconet device may have a location associated with them.

If direct piconet connection is made between a first device which has no inherent self-location abilities and another, second, device which does know its own location, then the first device may assume itself to be at the same, known, location as the second device (since they will only be meters apart). If the piconet connection between the first and second devices is indirectly through one or more other piconet members then said first device may or may not assume that it is close enough to the second device to enter its location as being the same as that of the second device. It may depend upon how many other devices are in the link. The location stamping may comprise communicating with a GPS system or other location-information providing system or device.

The creation of the activity logs of the piconet devices preferably occurs automatically without human intervention when the devices form a piconet.

A piconet record in an activity log may include the presence of piconet only devices which cannot be contacted by long range telecommunication (indeed missing items are just such devices)—if they could be contacted by long distance telecommunications they would probably not be “missing”. The activity log, or at least the search-requesting piconet device, has, or has access to, long range telecommunications addresses for those long-range telecommunications-capable said other piconet devices it encounters. This information is preferably exchanged by dual mode piconet devices when they meet in a piconet (dual mode being devices capable of both automatic short-range piconet formation and having long distance telecommunications capabilities).

According to a second aspect the invention comprises a method of locating a missing item, the item being capable of communicating its presence to a piconet telecommunications device, comprising;

(i) there being a plurality of piconet devices capable of forming a short range piconet;

(ii) having the piconet devices establish which other piconet devices are members of the piconet to which they belong at a particular point in time and having the piconet devices create an activity log correlating at least time and the identity of which piconet devices were in communication at that point in time;

(iii) establishing whether the missing item is present in the current piconet of a said piconet device and/or reviewing the activity log to establish whether a record exists of a historic piconet to which both the missing item and a contactable other piconet device belonged at the time that the historic piconet existed;

iv) establishing whether there is a known location for the historic piconet which most recently had as a member the missing item, and if so communicating that location to the user of the method to enable them to consider whether to investigate that known location to see if the missing item can be found.

It will be appreciated that once a “last known position” has been determined for the missing item it may be worth investigating the vicinity of that last known position to see if the missing item is there. This may or may not involve contacting piconet-capable devices at that location to see if the item is in a piconet with them. A person may simply physically visit the known location and look for the missing item. For example, if the backtracking through the activity log showed that the item was last in communication with the piconet device whose log is being screened in the office of Mr Smith, then it may be worth visiting Mr Smith's office, or personally telephoning him, to see if it is there (not necessarily electronic communication with a piconet device capable of covering his office).

This raises another possibility: it may be worth electronically contacting a known piconet device known to be in the locality of the place where the missing item was last known to be, even if that known piconet device was not actually in a historic piconet with the missing item. For example, a missing item may have been just out of contact with a piconet device, called for the sake of convenience “near-miss piconet device”, at the time it was left accidentally behind, and so the near-miss piconet device is not recorded as being in the historic piconet. However, some time later another piconet device, called for the sake of convenience “bridging-piconet device”, could have entered the vicinity and bridged the gap between the near-miss piconet device and the missing item. Thus when the search-requesting device asks the near-miss piconet device now, currently, whether the missing item is within its piconet, the near-miss device could answer “yes” by virtue of it being aware of the presence of the missing item via the bridging piconet device.

Thus the method may comprise identifying known piconet devices that are believed to be in the vicinity of the last known location of the missing item and determining whether the missing item is in a piconet with them.

According to a third aspect the invention comprises a piconet telecommunications device having a piconet receiver capable of receiving information about members of a piconet to which the device temporarily belongs and a controller; wherein the controller is arranged in use to capture a piconet activity log when the device comes within piconet range of other piconet devices, the piconet activity log comprising a record of which other devices were piconet members with the device and at what time that piconet existed and a positional location for the piconet at that time; and in which the controller is capable of receiving a request to search for a missing item of known identity and upon such request is adapted to screen the activity log to identify historic piconets known to the device to have contained the missing item and the positional location of the historic piconet which last contained the missing item, the device being adapted to communicate the last, piconet-known to the device, location of the missing item to the user.

The device may be a dual mode device having long range telecommunications ability as well as pico range. The controller may be adapted to establish the telecommunications address of piconet members and store them so as to be able to retrieve them in order to contact them at some time in the future, possibly to establish whether the missing item is in their current piconet. The device may be able to establish the nearest fixed device position, or last known position of a mobile device, that has long range telecommunications, near to the last known position of the missing item, and may be able to contact them to enquire whether the missing item is in their piconet. By “fixed device” is meant devices which are unlikely to be moved on a daily, or regular, basis.

The device may have a category of “favourite” locations, and corresponding long range telecommunication devices near or associated with these locations, possibly associated with them at certain times only (e.g. other co-workers mobile phones will be near ones office, probably from 9.00 am-5.00 pm Monday to Friday), and may contact such favourite/most likely devices to search for a missing item.

According to a fourth aspect the invention comprises a piconet telecommunications device having a piconet receiver capable of receiving information about members of a piconet to which the device temporarily belongs and a controller; wherein the controller is arranged in use to capture a piconet activity log when the device comes within piconet range of other piconet devices and to build up a log of which other devices were piconet members with the device and at what time that piconet existed, and also which of those devices are dual mode devices having both piconet capabilities and having long range telecommunication abilities, and to establish their long range telecommunication addresses; and in which the controller is capable of receiving a request to search for a missing item of known identity and upon such request is adapted to screen the activity log to identify historic piconets which contained the missing item and a dual mode device, and wherein the controller is adapted upon identifying such a dual mode device to contact it via long range telecommunications and to establish whether the missing item is in the current piconet of the dual mode device.

Preferably the device has a memory and the controller is adapted to store the device's activity log in the memory of the device.

Preferably the device is itself a dual mode device and has a long range telecommunications transmitter and receiver and the device contacts said dual mode device that is known at one time to have been in a piconet with the missing item using its long range telecommunication transmitter and receiver. An alternative to the device having its own long range telecommunications capability is to bring it close enough to a dual mode device and to form a piconet with such a device so as to use the long range capabilities of the piconetted dual mode device.

The controller preferably has the capability of recording in the activity log the geographical location of the device and associating the position of the device at a point in time with the piconet members at that point in time. The device may have a location identifier. This may be a GPS (global positioning satellite) system, or it may be some other position-fixing system, for example a triangulation based system using emitters and a positional signal receiver in the device. The device may be adapted to communicate with a position beacon, or a network of position beacons.

The device may have a clock to time-stamp piconets and their members at a particular time. Alternatively it may import the time from some external source.

The device is preferably a portable mobile device, usually electronic device, such as a mobile telephone, lap top computer, PDA, digital camera etc. However, it could be a more fixed device such as a PC, server, photocopier, scanner, printer, landline telephone, projector etc.

According to a fifth aspect the invention comprises a piconet network comprising a plurality of piconet devices in communication, the piconet devices having the functional capability of automatically exchanging with other devices in a piconet, without human intervention, information as to their identity, and of recording the identity of members of the piconet in an activity log or in respective piconet activity logs associated with each piconet device, the activity log(s) including the members of the piconet and a time at which the particular piconet with those particular members existed.

The piconet may contain member piconet devices, indeed usually will, which have already communicated their identity to other piconet members. The piconet may have members which do not record other devices in the piconet, but do inform other members of their presence, or which have already informed other members of their presence.

The piconet network may have devices in accordance with the third or fourth aspects of the invention, and/or may be capable of operating in accordance with the first or second aspects of the invention.

According to a sixth aspect the invention comprises a piconet telecommunication device having a piconet receiver capable of receiving information about members of piconets to which the device temporarily belongs, and a controller; wherein the controller is arranged in use to create automatically, without user intervention, when the device comes within piconet range of a piconet apparatus and communicates with said piconet apparatus, a piconet activity log which records the identity of the members of the piconet to which the device belongs.

Thus, a piconet activity log is created automatically by the article. Once it exists, different things can be done with it. The controller may be adapted to record the piconet members and the time at which members joined and/or left the piconet, as well as their identities, and/or it may be adapted to record the geophysical location associated with a piconet membership at a particular time. The device may have a geophysical location sensor adapted to provide details of the geophysical location of the device. The device is preferably portable, most preferably hand-portable and/or pocketable.

The controller of a piconet telecommunications device, with or without the facility to back-track through its activity log to look for the presence of a lost item, may have details of an associated item set associating a set of known items in a notional group, and the controller being adapted to monitor the piconet to which the device belongs and being adapted to generate an alarm when an item from said associated item set leaves the piconet. The alarm may be generated immediately that an associated item leaves the piconet, or after a delay. The alarm is adapted to attract the attention of the user via at least one of their senses (e.g. an audible alarm, visual alarm, vibrating/movement alarm, or any combination thereof).

The controller may be adapted to generate an alarm when it detects the absence from the piconet to which the device belongs of an item from the associated item set.

There may be a user-operable alarm cancellation input adapted to enable a user to stop an alarm. For example, a user could press a “stop” button to stop the alarm from sounding. The user may be able to disable the alarm for a selected associated item in advance of the item leaving the piconet, thereby avoiding the alarm from sounding at all. The user may be able to add items to the associated item group.

The controller may be adapted to generate a report analysing the piconet activity log and/or export the piconet activity log to another electronic device.

According to a seventh aspect the invention comprises a method of tracking piconet-capable articles in the physical environment of a piconet device comprising having the device automatically create without user input a piconet activity log of the identity of piconet capable articles which have formed an ad-hoc piconet with said device.

A time for membership of the piconet may be associated in the piconet activity log for piconet-capable articles. The time that an article joins and/or leaves the piconet may be recorded in the piconet log.

The method may comprise having an associated set of piconet member articles whose presence in the piconet is tracked, and generating an alarm when an article of the associated set of piconet member articles leaves the piconet.

Once a piconet activity log exists it is possible to generate a report analysing the contents of the piconet activity log. A report on articles in the present or historic piconets may be generated using the piconet activity log.

A report may be generated comprising at least one of the following reports:

(i) members of piconet at a particular time;

(ii) history of piconet membership for a selected piconet member device

(iii) correlation of piconet membership for selected first and second piconet member devices;

(iv) selected piconet device at selected physical location(s);

(v) piconet member devices that have been at selected physical location(s).

According to an eighth aspect the invention comprises a data carrierhaving a program encoded upon it, the program when loaded onto, or running on, a controller of a piconet device causing the piconet device to be a piconet device in accordance with the third, fourth or sixth aspect of the invention, and/or to perform the method of the first, second or seventh aspect of the invention, or to be part of a network in accordance with the fifth aspect of the invention.

Embodiments of the invention will now be described by way of example only, with reference to the accompanying drawings of which:

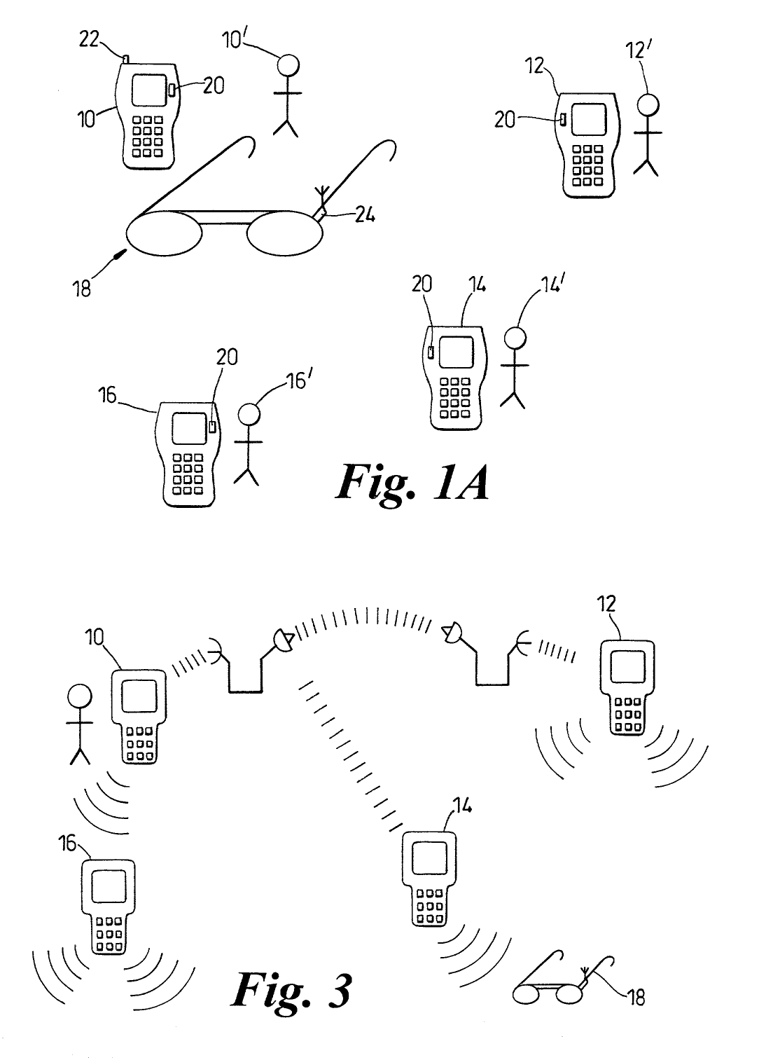

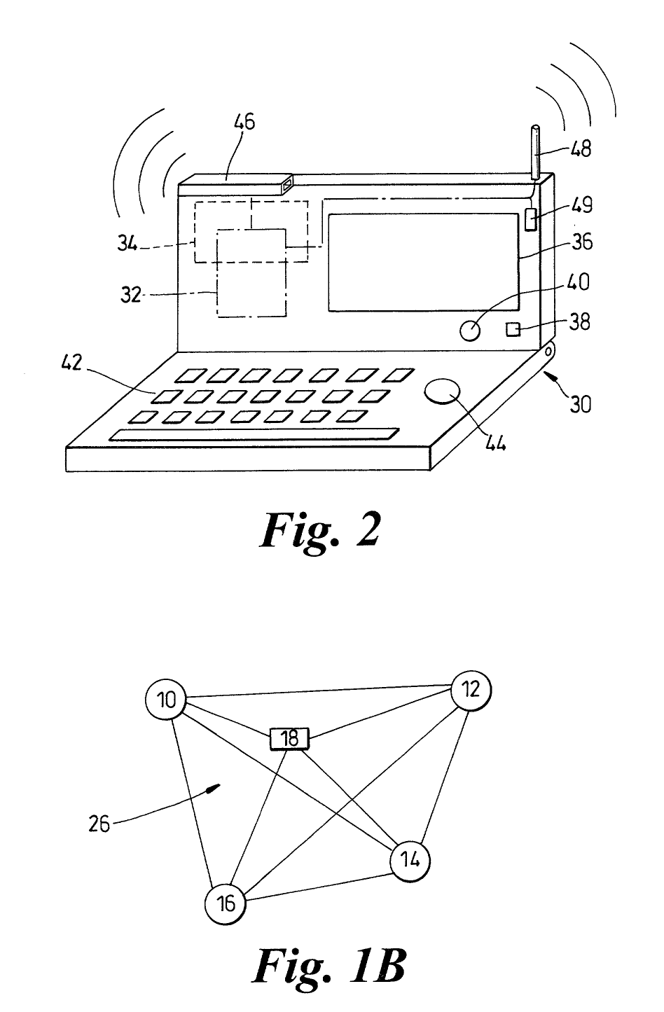

FIGS. 1A and 1B shows schematically a piconet network of devices in telecommunication;

FIG. 2 shows schematically a telecommunication device suitable for use in the network of FIG. 1;

FIG. 3 shows schematically a search for a lost item;

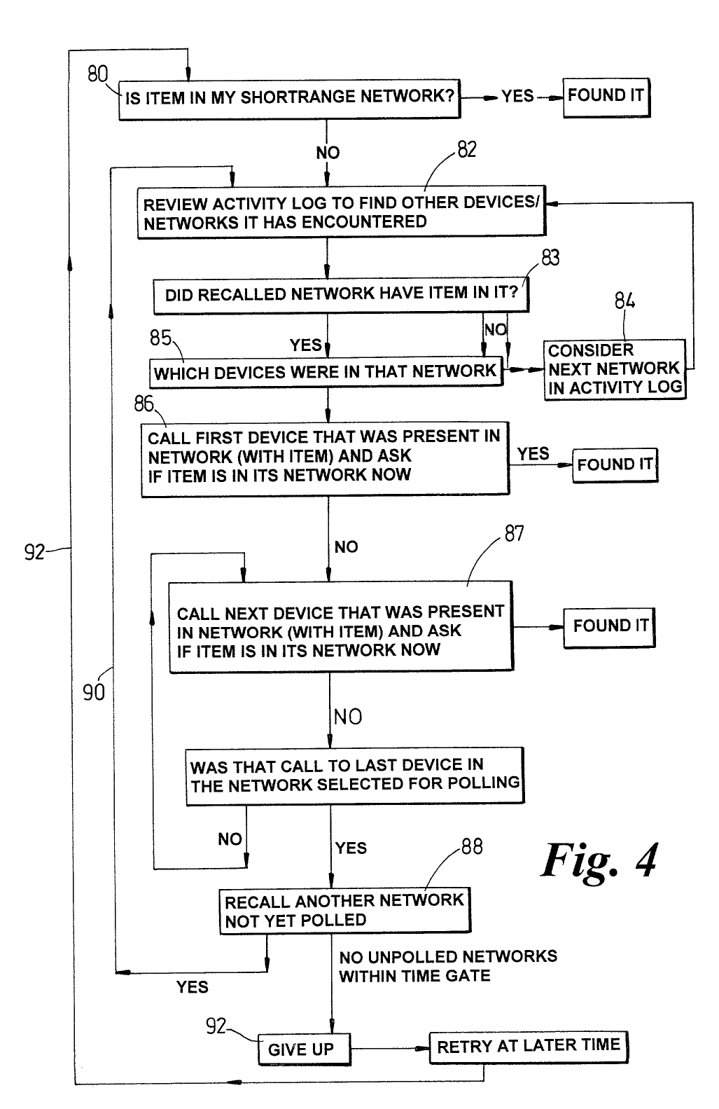

FIG. 4 shows a flow diagram of a search process;

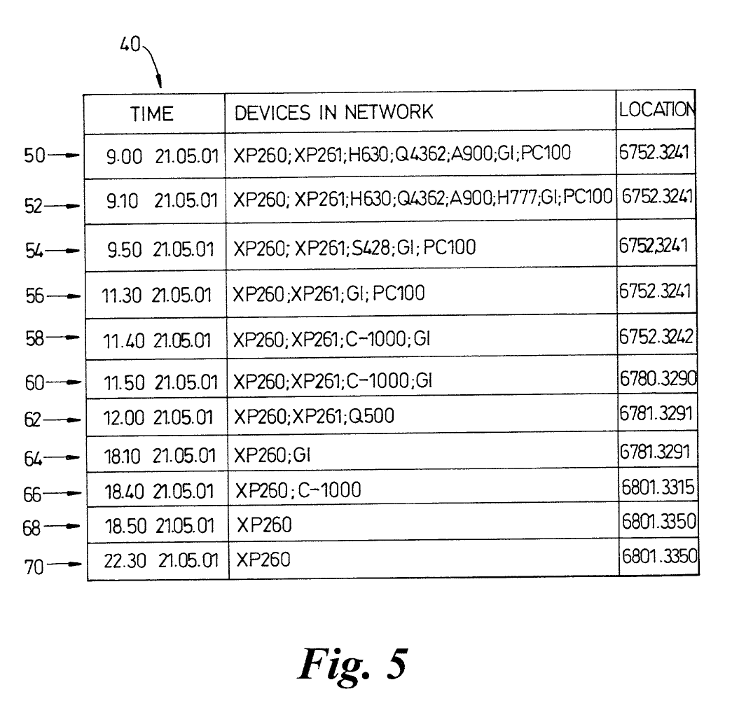

FIG. 5 schematically illustrates a back scan of an activity log of a device of FIG. 1;

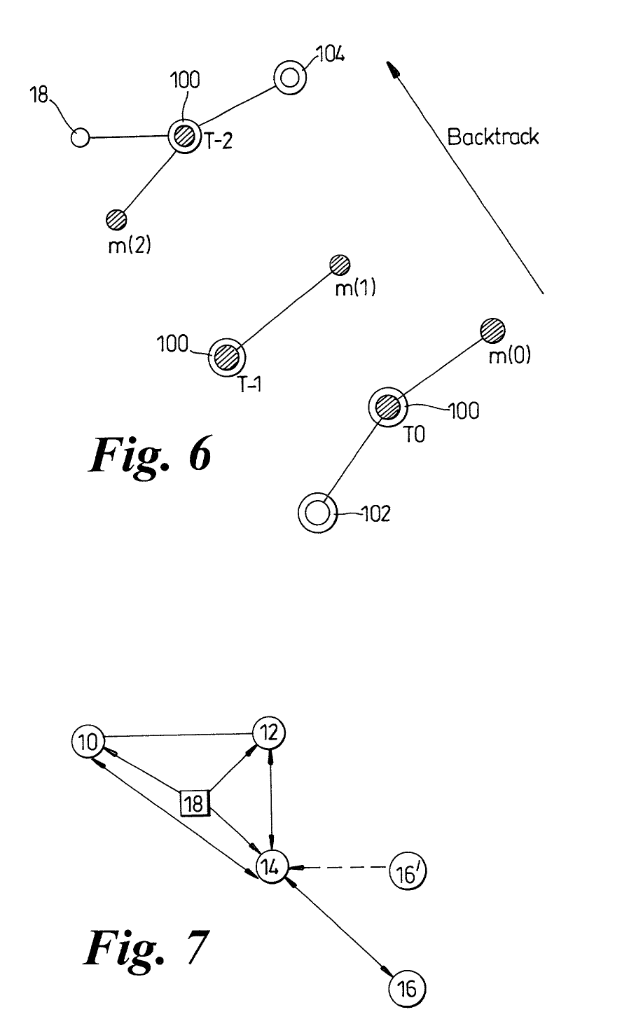

FIG. 6 schematically illustrates contacting devices that were at a previous time in a network with the lost item;

FIG. 7 shows a piconet having indirect communication between two member devices;

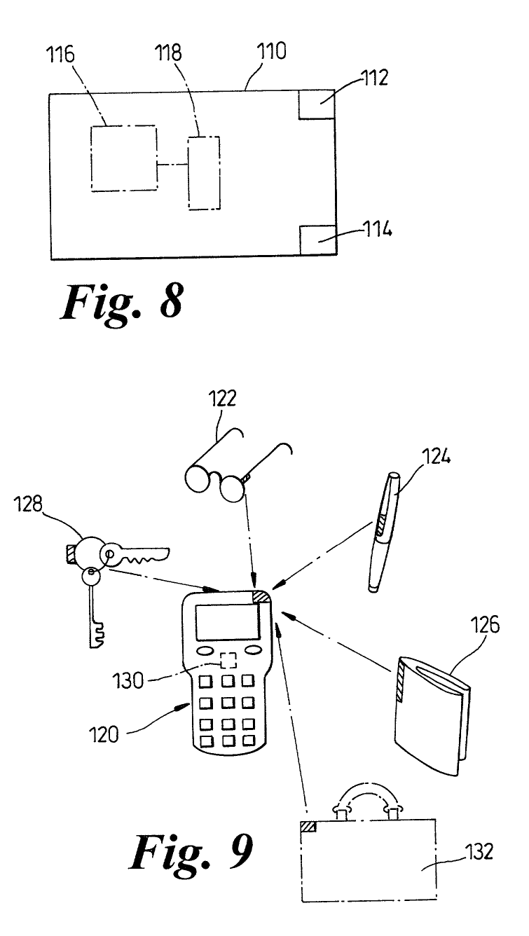

FIG. 8 shows another piconet device; and

FIG. 9 shows a further piconet device and some associated piconet-capable items.

FIG. 1 schematically shows a meeting in a room at a time T between four people 10′, 12′, 14′ and 16′, each person having their own respective mobile telecommunications device 10, 12, 14, 16. Person 10′ also has a pair of glasses 18. When the meeting breaks up each person goes their separate way and some hours later person 10′ realises that they do not have their glasses 18 with them and wishes to find them.

Each of the devices 10 to 16 is provided with a short range telecommunications transmitter and receiver, schematically referenced 20 (e.g. Bluetooth™ technology or IEEE 802.11). Device 10 also has a longer range cellular network telecommunications transceiver 22 (e.g. a mobile telephone-type antenna). Devices 12 to 16 in this example are mobile telephones (or at least have this capability as one of their capabilities), but they need not be. Indeed, device 10 need not necessarily have long range telecommunications ability, but it does in this example. By short range is primarily meant a few meters range to a few tens of meters range.

The glasses 18 have a short range transmitter 24 which is capable of communicating with the transceivers 20. The devices 10 to 16 and the glasses 18 form a network 26, with each member of the network in communication. This is schematically shown in FIG. 1B.

FIG. 2 shows a device 30 suitable for use with the network 26. The device 30 is a personal digital assistant, PDA, (instead of a mobile telephone as shown in FIG. 1) and has a control processor 32, a battery 34, a display screen 36, a microphone 38, a speaker 40, a key pad 42, a mouse (or cursor-pointing device) 44, a short range telecommunications transceiver (emits and receives) 46, and a longer range cellular transceiver 48. Transceiver 48 has cellular telephone capability and the PDA incorporates a mobile telephone (although it does not have to). Transceiver 48 is also connected to a GPS global positioning satellite) unit 49 which can fix the location of the PDA.

It will be appreciated that the mobile telephone 10 could have a GPS module.

During the meeting in the room at time T, the devices 10 to 16 interrogate other devices within range of their short range wireless telecommunication transceivers 20 to identify which devices are in the network 26. Those devices with some degree of intelligence, in this example devices 10 to 16, but not glasses 18, keep an activity log of their network activities, and the identity of members of the network 26, and the time at which that particular network exists, is stored in their activity logs.

In a modification, the devices 10 to 16 also store their physical location at the time that the network 26 exists. This physical location may be provided by a geosignal (e.g. a GPS signal) which one or more of the devices may be capable of receiving. If one device knows its geographical location it may share that information with other devices in the network (which will be in much the same geographical location since the short range telecommunications has a range of the order of meters, rather than hundreds of meters). One of the network devices may have a fixed position (i.e. not be a mobile device) and so its position may be known. The fixed position may be very fixed (e.g. a transducer in a wall) or it may be semi-permanently fixed (e.g. the device may be a photocopier, printer, or item of furniture which whilst they can be moved from room to room are often considered geostationary within the requirements of obtaining a general and probable fix on the location of a much more mobile device such as a PDA, cellular phone, briefcase, or pair of glasses).

The pair of glasses does not keep an activity log in this example because it is a simple transponder. Indeed the glasses may or may not have their own power source; the transponder 24 may convert the energy of incoming interrogation signals to an outgoing response signal. On the other hand, it could be battery powered, or otherwise powered by a power source.

FIG. 5 illustrates a possible activity log 40 for device 10. For the sake of this example the following apply:

| Device XP260 | is device 10, the mobile phone of person 10′ |
|---|---|
| Device XP261 | is device 12, the mobile phone of person 11′ who is a |
| | colleague of person 10′ |
| Device H630 | is the device 14 of person 14′ |
| Device Q4362 | is device 16 of person 16′ |
| Device A900 | is a PDA device of another person, person P1 |
| Device G1 | is the pair of glasses 18 |
| Device PC100 | is the desktop PC of person 10 |
| Device H777 | is the PDA of another person, person P2 |
| Device S428 | is the briefcase of another person, person P3 |
| Device C-1000 | is the on-board computer of the car of person 10′ |
| Device Q500 | is the mobile phone of another person, person P4 |
| Location | is the grid reference on a local area grid of the office of |
| 6752.3241 | person 10′ |
| Location | is the grid reference of the car parking space of person |
| 6752.342 | 10′ |
| Location | is the grid reference of the car park of the office of |
| 6781.3291 | person P4 |
| Location | is the grid reference for part of a road leading from the |
| 678.3350 | office of person 10′ to the office of person P4 |
| Location | is the home of person 10′ |
| 6801.3350 | |
| Location | is part of a road on the way to the home of person 10′ |
| 6801.3315 | |

The activity log 40 shows at line 50 that at 9.00 am on 21 May 2001 the mobile phone 10. (XP260) was in a short range network with the mobile phones XP261, H630, Q4362, and the PDA A900, and that glasses G1 were present, as was desktop PC 100. The location at that time for the network was 6752.3241—person 10's office.

It will be appreciated that the devices actively interrogate members of the network, or at least receive identity information from the members of the network automatically, without manual intervention. In this example they check the network for members, and establish their location, every 10 minutes (but it could be 5 minutes, 1 minute, 10 seconds, or other intervals, or even continuously).

At line 52 the activity log shows that device H777 has joined the network and that the location is still the office of person 10′ (the glasses G1 are still present in the network).

Line 54 shows that devices A900 and H777 have left the network, and hence the local vicinity, and that the local vicinity is still the office of person 10′. Device S428 has joined the network (the briefcase of person P3, who has presumably joined the meeting). The glasses G1 are present.

Line 56 shows that device S428 has left the network of device XP260.

Line 58 shows that at 11.40 am device XP260 (phone 10) was in a network with XP261, glasses G1 and the in-car computer C-1000, and that the location was the car parking space of person 10′ (i.e. person 10′ and person 11′ were in or near to the car of person 10′, which was in its car parking space).

Line 60 shows that the network members have moved location (driving along, presumably).

Line 62 shows that the network is at another location (the offices of person P4) and that device Q500 has joined the network (presumably a meeting with person P4), and that the in-car computer C-1000 is no longer in the network (the people have presumably gone into the offices of P4).

Line 64 shows that he location is still the offices of person P4 but that person 11′ and person P4 are no longer in the network with person 10′ but that his glasses are still with him (or at least that devices XP261 and Q500 have left the network of device XP260).

Line 66 shows that device XP260 (phone 10) at 18.40 pm is in a network only with the in-car computer C-1000, and that the glasses G1 (18) are not present in the network, and that the location is part-way home for person 10′. They are driving home.

Line 68 shows that the device 10/XP260 has no other devices in its network and is at the home of person 10′ at 18.50 pm.

Line 70 shows that at 22.30 pm there has been no change.

When person 10 realises that they do not have their glasses, at say 10.45 pm, they enter a “find glasses G1” command into their device 10. This then tries to find the glasses.

From the activity log 40 it is apparent that the mobile phone 10 (XP260) and the glasses 18 (G1) were last in communication over the short range network established by device 10 at 18.10 pm at the offices of person P4.

The controller 32 of the device 10 could use long distance telecommunications to contact a known master network device at location 6781.3291 to ask any such device if it is in a network with glasses G1. For example if the office of the person with mobile device Q500 had a fixed smart device, such as a fax machine, FX101, with short range telecommunication abilities and long range telecommunication abilities, then device 10 could call up device FX101 and ask it if device G1 is in its network. It is understood that when the devices in a network initially interrogate each other they exchange telephone numbers/email address/telecommunications contact details and store them in a directory associated with the respective device identification codes. The controller 32 could decide to do this by reviewing its log to see which dual mode smart (long range and short range) telecommunications device was in a network most recently with the device 10 and the lost item, glasses 18/G1.

However, initially in this example the device 10 follows the process set out in FIG. 4. Upon being requested to search for a lost item the processor 32 initially interrogates/investigates the current short range network (piconet) that the device 10 belongs to (reference 80 in FIG. 4). If the missing item is present that is the end of the search and the device 10 informs the user of this in some way (e.g. on a display, audibly, or by illuminating an appropriate indicator light). If the item sought is not present in the local short range network the device 10 then reviews its activity log to find other devices it has encountered in its history (reference 82). It can be considered that every change to a network status, be that a different combination of members of the network, or a different geographical position could be taken to be a different network/piconet.

If the most recent chronological network in which device 10 was a member does not have the item, glasses 18, as a member according to the activity log of device 10, then the device moves onto the next most recent network in its activity log and establishes if the missing item was a member of that (reference and 82 and 84). The activity log is scanned backwards chronologically from the present time backwards until a network is found in the activity log which did have the missing item in it. The controller then establishes which devices were in that network (reference 85) and establishes which of those devices are capable of being contacted by long distance, e.g. wireless cellular link, internet or land cable telecommunications. All devices captured in the data log will be capable of sending and/or receiving short range signals. The data log also distinguishes those devices which can receive and detect an incoming short range signal. Devices which can both receive and transmit a long range telecommunications signal from device 10 and which can receive a short range signal from the missing item glasses 18, are shortlisted. The device 10 then calls the first such shortlisted device via long range telecommunications and determines whether the first shortlisted device has, currently, the missing item in its short range network (piconet), referenced 86 in FIG. 4.

If the answer is “yes” then the device 10 has found the missing item and an appropriate indication of this is presented to the user of the device 10.

If the answer is “no” then the device 10 calls the next shortlisted device and asks that that if the missing item is currently in its network (reference 87). When the device 10 has called the last shortlisted device in whatever chronologically distant historic network is being screened and has a negative answer, it identifies the next most recent historic network that has not yet had its members polled for the presence, now, in their current network of the item (reference 88) and polls the devices in that network (90).

Eventually all search-allowed networks may be exhausted and the device 10 will report to the user a failure to find the item 18 (referenced 92). The device 10 may automatically re-try to find the missing item 18 a set time later (e.g. 4 hours later, or 8 hours, for example) referenced 92. Alternatively the user may have to select this function (or may deselect it).

By “all search-allowed networks” in the above is meant those networks which the search criteria will allow the device 10 to search. For example the search profile may have a rule that stops searching further back chronologically than 1 week. After all, if a device searched back a year or more it could be making thousands of telephone (or other telecomms) calls. The user may be able to set the cut-off date, or cut-off number of telecomms links before the device 10 stops.

It will be appreciated that in FIGS. 1a and 1b all of the devices 10 to 16 are in direct piconet communication with each other. However, there may be occasions when the piconet network comprises some devices that are in direct telecommunication and other devices that are only in indirect telecommunication, with a “linking” device in the network passing the details of one device to another indirectly (and possibly vice versa). This is shown in FIG. 7.

In FIG. 7 device 16 exchanges data with device 14, which also exchanges data with device 10. Thus device 10 is informed by device 14 that device 16 is in the piconet, and similarly device 16 is informed by device 14 of the presence of device 10, 12, and 18 in the piconet. The devices are informed of the identity of the other devices and if appropriate position information.

In the arrangement of FIG. 7 another modification is that device 16 is a relatively stationary device, for example a photocopier or PC, which is unlikely to move geographically very often. Device 16 has entered into it its own geographical location, possibly downloaded to it by a geo-stamping device which obtains GPS signals. Device 16 provides position information to the whole piconet 16, 14, 12, 10, 18 (none of which need have their own geographical position identifying capability if they use the position-location information from other devices in the piconet to geo-stamp their activity logs (position with time, as well as members of piconet with time).

FIG. 3 shows the same process as FIG. 4. Upon receiving a request to find glasses 18, device 10 first checks its own piconet for the missing item. It finds only device 16, and neither device 10 nor device 16 can detect the glasses 18 using their short range telecommunications.

Device 10 then uses its wireless cellular network telecommunicates ability to contact device 12, which in turn checks for the glasses 18 in its local piconet. Upon failing to find the glasses associated with the piconet in which device 12 resides the device 10 contacts device 14 via its cell-phone technology and asks device 14 if the glasses 18 are part of its piconet. Device 14 replies “yes”, and the glasses are found.

Similarly, FIG. 6 shows locating lost items by backtracking through the activity log of a telecommunications device. At time Tₒ the master network device M_{O} is in contact with a cellular phone 100 and another device 102, but not glasses 18. A check of the activity log of device M_{O} shows that at time −1, in the past, the master device M at time−1, M(1) was in contact only with cellular phone 100. At time T−2, even further back in time the master device M, at time−2, M(2) was in communication with mobile phone 100, device 104, and glasses 18. The master device M therefore knows to ask mobile phone 100 and device 104 if they are in contact with the glasses, but not to bother asking device 102.

In a modification, the device 10 may keep a check if the devices it has contacted in a search run and may once it has already asked a particular device earlier in the search run whether the lost item is in its current piconet, exclude that device from being contacted again when the device screens another network which may have the same previously interrogated device in it. This can avoid the same device, that was present in two or more earlier networks along with the lost item, from receiving more than one search interrogation call.

The lost item will usually be a real physical thing, often an item of personal movable property, such as glasses, briefcase, pen, etc. However, it could be an electronic item such as a data record. For example the device 10 might keep only titles of reports, or a precis of documents, possibly obtained automatically by automatic telecomms exchange between two devices, and the search for a missing, or lost, item could be a search for a full data record, or for the device that has the full data record on it (possibly, so that device 10 could download more of the report later, or all of the report, under the instruction of person 10 or automatically upon finding the fuller report/document).

The activity log or record of a device may check for member devices of its piconet periodically and may update its activity log with each check. Alternatively, it may update the log only when there is a change (eg of members, and/or of geographical position). The piconet membership and/or location may be checked by a device at any suitable interval, typically ranging from every few seconds to every few minutes, to every few tens of minutes, or hours.

The invention is perhaps most useful when an activity log of dual mode devices (both piconet and long range telecommunications capabilities) are identified as being in a piconet, at one time, with a missing item.

In another embodiment shown in FIG. 8, a piconet-telecommunications device 110, in this case a PDA, has a piconet emitter 112 and receiver 114, a control processor 116, and a memory 118. The control processor 116 keeps track of other piconet members with which the device 110 is in wireless piconet telecommunication and creates a piconet activity log which it stores in the memory 118. The piconet activity log has details of the time, and the members of the piconet at the time. The control processor 114 is adapted automatically to record a piconet device joining or leaving the piconet and timestamp that event, with details of which device joined or left. In this embodiment the device 110 also records details of who it can detect in its piconet periodically (e.g. every 10 minutes), as a back up to the tracking of joining/leaving members (but this back up could be omitted, or instead of monitoring joining/leaving events the device could simply record membership details periodically).

Once the device 110 has a piconet activity log there are a number of things that can be done with it. One such thing is, of course, to back track through it to look for lost items and to ascertain what other devices were in the piconet at the last time that the lost item was in it.

Another use for the piconet activity log is to check/verify that certain people (or at least their device) are where they should be. With a knowledge of physical location, the device 110 could have a CPS or other positioning system/capability, or it could learn its physical position from other location-aware devices, it is possible to see who was where.

Similarly, the piconet activity log can be used to track who was present at what meetings (and so, possibly, who definitely knew what, or at what time).

Another potentially significant use is to track the movement of physical articles and/or people carrying them. For example, if there is only one projector it can be helpful to track its whereabouts over time. (For example the activity log can be used to see if any person is not sharing a shared resource item properly, or perhaps needs their own because of the amount of usage they make of it).

Utilisation of items (e.g. photocopiers, projectors, shared lap-top computers, pool cars, hot desks, meeting rooms etc) can be logged and tracked by using the automatically generated piconet activity log (assuming that those items/rooms have a piconet capable device, possibly with the ability to build up its own activity log). The piconet activity log of such shared resources can be evaluated/interrogated to determine if they are cost-effective and/or whether they could be sited better, or whether they are at acceptable capacity and are causing problems due to a lack of availability.

FIG. 9 shows another piconet device 120, this time a hybrid mobile telephone having both long range cellular telecommunications capabilities and short range piconet capabilities, and also a family of associated items 122-128. The device 120 has a control processor 130 which maintains a piconet activity log to record piconet members with which the device 120 is in piconet communication. In this example item 122 is a pair of glasses, item 124 is a pen, item 126 is a wallet, and item 128 is a set of keys.

The control processor is configured to produce an alarm if one of the associated articles is absent from the piconet. For example, the telephone 120 may ring and a message “Keys Missing” may appear in the screen of the telephone if the keys go out of piconet range. In this way a person can avoid accidentally losing items of the predetermined set.

A person may be able to input/identify items to the device 120 in order to add their identity to the associated set of articles. Similarly, a person may be able to delete items from being in the associated set, preferably using input controls (e.g. keys) on the device 120.

A person may be able to turn off the alarm to override it, either in advance of it being given and/or after it has been given.

FIG. 9 also shows an article, in this case a briefcase 132, which can be selectively included in the associated set or excluded from it dependent upon a user-input command input to the device 120 (e.g. by pressing keys on the telephone). Thus when a person knows that they are not taking their briefcase with them they can disable the alarm feature which would otherwise alert them to the fact that their briefcase is out of piconet range. There may be a plurality of items that can be selectively included or not included in the associated group by the user.

The items of the associated group of items may comprise items personal to an individual.

1. A method of locating a missing item, the item being capable of communicating its presence to a piconet telecommunications device, comprising:
(i) there being a plurality of piconet devices capable of forming a short range piconet;
(ii) having the piconet devices establish which other piconet devices are members of the piconet to which they belong at a particular point in time, and having the piconet devices create an activity log correlating at least time and the identity of which piconet devices were in communication at that point in time;
(iii) establishing whether the missing item is present in the current piconet of said piconet device and/or reviewing the activity log to establish whether a record exists of a historic piconet to which both the missing item and a contactable other piconet device belonged at the time that the historic piconet existed.

2. A method according to claim 1 which includes the step of contacting said other piconet device and establishing whether the missing item is part of the piconet that now includes other piconet device.

3. A method according to claim 1 or claim 2 in which each piconet device preferably creates its own activity log and stores it in itself, in its own memory.

4. A method according to claim 1 or claim 2 in which a piconet device stores its activity log remote from itself.

5. The method of any preceding claim comprising having a search-requesting piconet device check its own piconet for the presence of the missing device before screening the activity log, or its own piconet activity log to look for a historic piconet to which both itself, the missing item, and said other piconet device belonged, and then contacting said other piconet to establish whether the missing item is part of the current piconet of said other piconet device.

6. The method of claim 5 comprising having the search-requesting piconet device and said other piconet device be capable of long range telecommunication and having the search-requesting device contact said other device using its long range telecommunications capabilities.

7. The method of any preceding claim comprising asking piconet devices with long range telecommunication capabilities whether the missing item is presently in their local piconet in reverse chronological order that they are known from the activity log to have been in contact with the missing item.

8. The method according to any preceding claim comprising having a cut off point beyond which the search does not backtrack for contacts.

9. The method of any preceding claim comprising either using (i) a search-requesting piconet device which itself has a long distance telecommunication capability; or (ii) using a device which has only piconet range telecommunications but that is in contact with a piconet member which does have long distance telecommunications ability and uses their long range telecommunications; to contact said other devices.

10. The method according to any preceding claim comprising sequentially asking those other piconet devices that are identified from the activity log for information on whether the missing item is in their current piconet.

11. The method according to any one of claims 1 to 9 comprising simultaneously or substantially simultaneously asking a plurality of said other devices for information on whether the missing item is in their current piconet, without waiting for a reply from the first said other device interrogated.

12. The method of any preceding claim further comprising having the piconet devices record their geographical, or physical, location at the time that a piconet exists.

13. The method of claim 12 further comprising making piconet connection between a first device which has no inherent self-location abilities and another, second, device which does know its own location, and having the first device assume itself to be at the same, known, location as the second device.

14. The method of any preceding claim wherein the creation of the activity logs of the piconet devices occurs automatically without human intervention when the devices form a piconet.

15. A method of locating a missing item, the item being capable of communicating its presence to a piconet telecommunications device, comprising;
(i) there being a plurality of piconet devices capable of forming a short range piconet and forming a piconet with those devices;
(ii) having the piconet devices establish which other piconet devices are members of the piconet to which they belong at a particular point in time and having the piconet devices create an activity log correlating at least time and the identity of which piconet devices were in communication at that point in time;
(iii) establishing whether the missing item is present in the current piconet of a said piconet device and/or reviewing the activity log to establish whether a record exists of a historic piconet to which both the missing item and a contactable other piconet device belonged at the time that the historic piconet existed;
(iv) establishing whether there is a known location for the historic piconet which most recently had as a member the missing item.

16. A method according to claim 15 comprising communicating the last known location of the missing item to the user of the method to enable them to consider whether to investigate that known location to see if the missing item can be found.

17. The method of claim 15 or claim 16 comprising visiting the vicinity of the last known position of the missing item to see if the missing item is there, or contacting a person or device in the vicinity of the last known position of the missing item to enquire after the item.

18. The method of any one of claims 15 to 17 comprising electronically contacting a known piconet device known to be in the locality of the place where the missing item was last known to be, and enquiring whether the missing item is detectable by the contacted device.

19. The method of any one of claims 15 to 18 comprising identifying known piconet devices that are believed to be in the vicinity of the last known location of the missing item and determining whether the missing item is in a piconet with them.

20. A piconet telecommunications device having a piconet receiver capable of receiving information about members of a piconet to which the device temporarily belongs and a controller; wherein the controller is arranged in use to capture a piconet activity log when the device comes within piconet range of other piconet devices and to build up a log of which other devices were piconet members with the device and at what time that piconet existed, and also which of those devices are dual mode devices having both piconet capabilities and having long range telecommunication abilities, and to establish their long range telecommunication addresses; and in which the controller is capable of receiving a request to search for a missing item of known identity and upon such request is adapted to screen the activity log to identify historic piconets which contained the missing item and a dual mode device, and wherein the controller is adapted upon identifying such a dual mode device to contact it via long range telecommunications and to establish whether the missing item is in the current piconet of the dual mode device.

21. A piconet telecommunications device having a piconet receiver capable of receiving information about members of a piconet to which the device temporarily belongs and a controller; wherein the controller is arranged in use to capture a piconet activity log when the device comes within piconet range of other piconet devices, the piconet activity log comprising a record of which other devices were piconet members with the device and at what time that piconet existed and a positional location for the piconet at that time; and in which the controller is capable of receiving a request to search for a missing item of known identity and upon such request is adapted to screen the activity log to identify historic piconets known to the device to have contained the missing item and the positional location of the historic piconet which last contained the missing item, the device being adapted to communicate the last, piconet-known to the device, location of the missing item to the user.

22. A device according to claim 20 or claim 21 which has a memory and in which the controller is adapted to store the device's activity log in the memory of the device.

23. A device according to any one of claims 20 to 22 which is a dual mode device having a long range telecommunications transmitter and receiver, and in which the device is adapted to contact said dual mode device that is known at one time to have been in a piconet with the missing item, or to contact a piconet device near the last known position of the missing item, using its long range telecommunication transmitter and receiver.

24. A device according to any one of claims 20 to 23 in which the controller has the capability of recording in the activity log the geographical location of the device and associating the position of the device at a point in time with the piconet members at that point in time.

25. A device according to claim 24 which has a location identifier.

26. A device according to any one of claims 20 to 25 which has a clock and is adapted to time-stamp piconet membership data at a particular point in time using its clock; or which is adapted to import the time from an external source and adapted to time stamp the details of which devices were members of the piconet at a certain time.

27. A device according to any one of claims 20 to 26 which is a portable mobile electronic device

28. A device according to any one of claims 20 to 27, in which the controller is adapted to establish the telecommunications address of piconet members and store them so as to be able to retrieve them in order to contact them at some time in the future.

29. A device according to any one of claims 20 to 28 which is adapted to establish the nearest fixed device position, or last known position of a mobile device, that has long range telecommunications, near to the last known position of the missing item, and to contact them to enquire whether the missing item is in their piconet.

30. A device according to any one of claims 20 to 29 which has details of predetermined favourite locations, and corresponding address for long range telecommunication devices which are equipped for piconet communication and which are near or associated with these locations, and which is adapted to contact such devices as part of a search for a missing item.

31. A piconet network comprising a plurality of piconet devices in communication, the piconet devices having the functional capability of automatically exchanging with other devices in a piconet, without human intervention, information as to their identity, and of recording the identity of members of the piconet in an activity log or in respective piconet activity logs associated with each piconet device, the activity log(s) including the members of the piconet and a time at which the particular piconet with those particular members existed.

32. A piconet according to claim 31 which has a device in accordance with any one of claims 20 to 30 and/or is capable of operating in accordance with any one of claims 1 to 19.

33. A piconet telecommunications device having a piconet receiver capable of receiving information about members of piconets to which the device temporarily belongs, and a controller; wherein the controller is arranged in use to create automatically, without user intervention, when the device comes within piconet range of a piconet apparatus and communicates with said piconet apparatus, a piconet activity log which records the identity of the members of the piconet to which the device belongs.

34. A device according to claim 33 wherein the controller is adapted to record the piconet members and the time at which members joined and/or left the piconet, as well as their identities.

35. A device according to claim 33 or claim 34 wherein the controller is also adapted to record the geophysical location associated with a piconet membership at a particular time.

36. A device according to claim 35 wherein the device has a geophysical location sensor adapted to provide details of the geophysical location of the device.

37. A device according to any one of claims 33 to 36 which is portable.

38. A device according to claim 37 which is hand-portable and pocketable.

39. A device according to any one of claims 20 to 30, or 33 to 38, further comprising the controller having details of an associated item set associating a set of known items in a notional group, and the controller being adapted to monitor the piconet to which the device belongs and being adapted to generate an alarm when an item from said associated item set leaves the piconet.

40. A device according to claim 39 wherein the controller is adapted to generate an immediate alarm and the alarm is adapted to attract the attention of the user via at least one of their senses.

41. A device according to claim 39 or 40 wherein the controller is adapted to generate an alarm when it detects the absence from the piconet to which the device belongs of an item from the associated item set.

42. A device according to any one of claims 39 to 41 having a user-operable alarm cancellation input adapted to enable a user to stop an alarm.

43. A device according to any one of claims 20 to 30, or claims 33 to 42 wherein the controller is adapted to generate a report analysing the piconet activity log and/or export the piconet activity log to another electronic device.

44. A method of tracking piconet-capable articles in the physical environment of a piconet device comprising having the device automatically create without user input a piconet activity log of the identity of piconet capable articles which have formed an ad-hoc piconet with said device.

45. A method according to claim 44 comprising associating in the piconet activity log a time for membership of the piconet for piconet-capable articles.

46. A method according to claim 45 comprising recording in the piconet log the time that an article joins and/or leaves the piconet.

47. A method according to any one of claims 1 to 19 or any one of claims 44 to 46 comprising having an associated set of piconet member articles whose presence in the piconet is tracked, and generating an alarm when an article of the associated set of piconet member articles leaves the piconet.

48. A method according to any one of claims 1 to 19 or claims 44 to 47 comprising generating a report analysing the contents of the piconet activity log.

49. A method according to any one of claims 1 to 19 or claims 44 to 48 comprising generating a report on articles in the present or historic piconets using the piconet activity log.

50. A method according to claim 48 or claim 49 comprising generating at least one of the following reports:
(i) members of piconet at a particular time;
(ii) history of piconet membership for a selected piconet member device;
(iii) correlation of piconet membership for selected first and second piconet member devices;
(iv) selected piconet device at selected physical location(s);
(v) piconet member devices that have been at selected physical location(s).

51. A data carrier having a program encoded upon it, the program when loaded onto, or running on, a controller of a piconet device causing the piconet device to be a piconet device in accordance with any one of claims 20 to 30 or claims 33 to 43; and/or to perform the method of any one of claims 1 to 19 or claims 44 to 50; or to be part of a network in accordance with claim 31 or claim 32.
